(19) United States
(12) Patent Application Publication
(10) Pub. No.: US 2010/0071044 A1
(43) Pub. Date: Mar. 18, 2010

(54) Method for tracking location of patients and doctors in a medical office or hospital practice

(76) Inventor: Taussif Khan, Monroe, NJ (US)

Correspondence Address: Charles I. Brodsky, Esq., 2 Bucks Lane, Marlboro, NJ, 07746, US

(21) Appl. No.: 12/585,414

(22) Filed: Sep. 15, 2009

Related U.S. Application Data
(60) Provisional application No. 61/192,226, filed on Sep. 17, 2008.

(51) Int. Cl. H04L 9/32; G08B 13/14; G06F 21/00

(52) U.S. Cl. 726/7; 340/572.1

(57) ABSTRACT

A method of operating a paperless medical office or hospital practice office of multiple physicians seeing multiple patients during the course of a single day through the use of radio-frequency identification transponder tags secured within the walls, ceilings and/or doors of examination and consultation rooms of a health-care environment in cooperation with codified smart cards or fingerprint scans in physician carried tablet PC's to supply medical record and like information relevant to a patient only to the physician with whom such patient is meeting at any given instant of time.

### CROSS-REFERENCE TO RELATED APPLICATIONS

A Provisional Patent Application covering the invention described herein was filed Sep. 17, 2008, and assigned Ser. No. 61/192,226.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to radio-frequency identification (RFID) tags or transponders, in general, and to the use of passive, active, and/or semi-passive transponders as may be employed in an electronic medical record keeping system, in particular. More specifically, the invention relates to a method that streamlines the day-to-day operations of any medical or hospital office utilizing multiple numbers of tablet personal computers (PC's), mainframes, servers, and small communication devices.

2. Description of the Related Art

As will be appreciated, mobile tablet PC's are oftentimes employed in a medical office or hospital practice for electronically receiving medical records and charts as to a patient being treated. As will also be appreciated, these mobile tablet PC's are also employed in other industries—such as in the carpet industry where sales representatives enter measurements taken of the flooring in a perspective purchaser's rooms, which are then automatically transmitted to a main office where price calculations are made and where orders for the selected floor coverings are placed.

As will become clear from the following description, the use of these tablet PC's is expanded, according to the invention, for a paperless medical office or hospital practice of multiple physicians seeing multiple patients during the course of a single day. In this expanded version of use, the doctor, for example, will immediately have available to him upon entering the examination room or examination area such items as:
a. A means of verification of the patient's identity;
b. All available charts and records of that patient;
c. Advice as to how long the patient has been waiting for the doctor (whether an appointment had been scheduled or not);
d. A manner of messaging with the front desk such items as prescriptions to be issued, further appointments to be scheduled, and tests to be taken;
e. A method of receiving automatically the results of tests ordered;
f. A manner to make and receive telephone calls;
g. A dictation and/or transcription of the information obtained during the examination and the doctor's recommendations pertaining thereto; and
h. A summarization as to each patient seen that day, the time spent in treating, and the results of such visits.

As will be appreciated by those skilled in the art, all this can be accomplished with such present day technology as fingerprint scanners, smart cards, blue tooth devices, headsets, and with any one of a number of Servers with which the tablet PC operates. As with all this, it will be appreciated that the advantages that accrue from this “paperless resulting system” follow from the fact that everything can happen once there is a verification that Patient No. 1 is in examination room A being seen by Dr. Smith—and not by Dr. Jones, who is then seeing Patient No. 2 in examination room B.

### SUMMARY OF THE INVENTION

As will become clear from the following description, the present invention utilizes the application of 3-D position determination using radio-frequency identification (RFID). Generally, the invention relates to these types of wireless communications—and, more specifically, to determining the location of these tablet PC's devices. The implementation will be seen to deal not only with determining the PC's location, but also the status of their operation, and then the delivering and processing of the information on that device.

As a reading of the following description will indicate, this follows from the method of the invention for tracking the location of patients and doctors in a medical office or hospital practice environment. Besides the present invention relating generally to wireless communication devices, and in determining the location of the devices, the method of the invention deals not only with determining their location, but also the status of the wireless communication device so that the delivering and processing of the invention can follow on the tablet PC.

### DETAILED DESCRIPTION OF THE INVENTION

As will be readily understood, radio-frequency identification is essentially an automatic identification method which relies on the storing and remote retrieving of data using RFID tags, or transponders. As is also well known and understood, these RFID tags are available in three general varieties—namely, passive, active and semi-passive.

a. The passive RFID tags have no internal power supply. Instead, an incoming radio-frequency signal induces a minute electrical current in its antenna—which provides just enough power for the semiconductor integrated circuit in the tag to power up and transmit a response. Because of this, the antenna in the tag needs to be designed both to collect power from the incoming signal, and to transmit its outbound response. Having practical “read” distances from 10 cm up to a few meters, these passive tags are suitable for manufacture through a printing process for the antennas. As such, and having no onboard power supply, the passive tag can be quite small and cost effective—with their operating “read” distances depending upon the chosen radio-frequency and the antenna design/size.

b. Active and semi-passive tags on the other hand require a power source—usually a small battery. Having practical “read” distances greater than that of the passive RFID tags, they suffer the disadvantages of being physically larger and being more expensive.

In accordance with the present invention, 2 types of RFID devices are employed in the system operation:
1. A read-only low-frequency passive RFID transponder tag, and
2. The doctor's mobile tablet PC device with an embedded RFID reader.

The low-frequency passive tag is secured within the walls, ceilings, doors, etc. of the examination room or area to connect with the Server when either Dr. Smith or Dr. Jones enters the location carrying his/her tablet PC. Each such tablet PC may be assigned to each physician in the office or hospital, and patient security is enhanced by the PC having the ability to receive a smart card or a fingerprint scan for that doctor so that it is assured that only that doctor seeing that patient in that examination room or area can deal with that patient's history and with that patient's treatment. In similar manner, a fingerprint scan of the patient may be incorporated with the tablet PC in connecting only that patient's charts and treatment plan with that doctor then treating him/her in that examination room or area to which that patient has been assigned by the front desk. This system will be understood to be scaleable—by replacing low-frequency passive tags within the walls, ceilings, doors, etc. with high-frequency passive or active tags to increase the maximum readable range (while also adding such features as a read-write capability for the PC). In the medical office and/or hospital environment, these will be seen to add a monetary cost to the system, and possible radio wave signal health concerns of all the transmissions then taking place.

The RFID embedded reader is understood to be attached to the doctor's mobile tablet PC device. Such RFID reader is always on, receiving information from the various low-frequency passive RFID transponders tags as the doctor carries the mobile tablet PC through the examination area—be it when opening or closing doors, walking through hallways, being in different examination locales. Each transponder tag contains a unique identification string such that when read by the RFID reader, that tablet PC is translated into a physical location—the identifying string being stored on the doctor's mobile device or at a main database. With the last scanned location being assumed to be the current location of the doctor, the system works such that with Dr. Smith entering room A, his/her mobile tablet PC reads the RFID tag in the doorway, knowing this as the tag ID number for examination room A. The system updates the network to reflect this so that it is then known that Dr. Smith is seeing a patient in room A. To verify that it is patient No. 1 that Dr. Smith is about to treat, the tablet PC can be controlled by the server to then display a previously taken photograph of patient No. 1—or a signature comparison can be made, or a fingerprint scan or like check could be administered.

With active RFID transponder tags or with higher frequency passive tags, one skilled in the art would realize that it is possible for Dr. Smith's PC to read several transponder tags within the treatment area at the same time. As a possible future implementation, the precise location of the doctor's tablet PC mobile device can be determined through a triangulation of received signal power. The following equation would apply in this instance to an RFID transponder tag using a loop antenna to receive, and a dipole antenna to relay, information back to the server:

P_{forward}=P_{IT}+G_{IT}+G_{TR}−L:_{c}−20 log(4 nR/l)

Pᵣₑₜᵤᵣₙ=P_{IT}+G_{IT}++G_{TR}+G_{TT}+G_{IR}−2LC−40 log(4 nR/l)

where

P_{IT}=Interrogator transmit power [dBm]

G_{IT}=Interrogator transmit antenna gain [dBi]

G_{TR}=Transponder receive antenna gain [dBi]

L:_{c}=Antenna cable loss [dB]

G_{IR}=Interrogator receive antenna gain [dBi]

G_{TT}=Transponder transmit antenna gain [dBi]

R=Range [ft]

l=Wavelength [ft]

Once the location information as to the patient being treated, the identity verification of the patient, and the doctor doing the examination are established, that can all be shared with the components of the local network for the medical office or hospital practice. This could be with not only the doctor's own mobile tablet PC, but with the local PC's of the receptionists, the central office's database, and with a temporary storage buffer (as for patients who are only in the office temporarily for the day, as compared to a storage of the patient information that the doctors have ever seen over the lifetime of the practice). The location of the doctor's mobile tablet PC device will be seen to be updated constantly, and in real time. In this manner, the doctor will be able to keep track of how many patients seen that day, how long each patient was seen for, and what transpired.

Thus, in a typical usage, after examining patient No. 1 in examination room A, Dr. Smith could message the front desk to take patient No. 1 to the Radiology Department for x-rays to be taken. Dr. Smith could then proceed to examination room B where patient No. 2 has been waiting for 15 minutes. After seeing patient No. 2, Dr. Smith could return to examination room A to see patient No. 1 after his/her return from radiology. The x-ray scan could be electronically sent for viewing by Dr. Smith on his/her tablet PC, and then electronically sent, for example, to a nearby printer for read-out, as well as for being stored by the server in patient No. 1's folder. Dr. Smith, at the same time, could electronically access on his mobile tablet PC any medical reference that might be helpful in explaining the x-ray to patient No. 1—again with the information being transmitted to him/her in examination room A where the passive RFID tag continues to show the doctor being present along with the patient.

It will thus be seen that the present invention sets out a wireless system method which will allow for an increase in patient flow with a concomitant reduction in possible error information transmission. The system method further implements the electronic medical record environment in streamlining the day-to-day operations of the medical or hospital office practice through the combination of multiple mobile table PC's, mainframes, servers, mail works and small communication devices as with the blue tooth headset. As contrasted with prior passive/active network arrangements, the described system method represents an “inversion”, wherein the rooms are passive (in not connecting to anything else), while the tablet PC is the one that communicates with the server in contrast with the room, itself, communicating with the server. The overall results will be seen to be a network capable of delivering patient records, medical history, billing information, etc. to a mobile device in a wireless connection arrangement.

While there has been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

What is claimed is:

1. A method of operating a paperless medical office or hospital practice office of multiple physicians seeing multiple patients during the course of a single day comprising the steps of:
utilizing radio-frequency identification transponder tags embedded in the mobile tablet PC's carried by the physicians through an examination area in which RFID transponder tags are secured within the walls, ceilings and/doors of the examination and consultation rooms thereof in determining the location of each physician at any time;
assigning individual smart cards or fingerprint scans codified for each physician's tablet PC to assure that only the physician meeting with an identified patient will be capable of communications through his/her tablet PC with a computer network providing medical information relevant to that identified individual patient only; and
including in each such tablet PC a fingerprint or photograph scan unique to that identified patient being seen to assure that only medical information relevant to that identified patient will be capable of being accessed by the treating physician through his/her tablet PC at the time of coincident activation when meeting.

2. The method of claim 1 including the further step of assigning individual smart cards or fingerprint scans codified for each physician's tablet PC to allow communications through each physician's tablet PC to the medical or hospital office central database or staff in real time.

3. The method of claim 2 including the additional step of utilizing read-only low-frequency passive RFID transponder tags secured within the walls, ceilings and/or doors to connect with the computer network servers whenever a physician enters the examination and consulting room area carrying his/her tablet PC.

4. The method of claim 2 including the additional step of utilizing read-only high-frequency passive or active RFID transponder tags secured within the walls, ceilings and/or doors to connect with the computer network servers whenever a physician enters the examination and consulting room area carrying his/her tablet PC.

5. The method of claim 2, including the additional step of assigning individual smart cards or fingerprint scans codified for each physician's tablet PC to allow communications through each physician's tablet PC to the medical or hospital office central database or staff in real time for the delivery to such tablet PC of patient records, medical history, and billing information.
